(19) United States
(12) Patent Application Publication
(10) Pub. No.: US 2023/0016229 A1
(43) Pub. Date: Jan. 19, 2023

(54) SELECTIVE INFRARED THERMAL EMISSION AND STEALTH PROPERTIES OF MXENES

(71) Applicant: DREXEL UNIVERSITY, Philadelphia, PA (US)

(72) Inventors: Meikang HAN, Philadelphia, PA (US); Yury GOGOTSI, Warminster, PA (US)

(21) Appl. No.: 17/782,234

(22) PCT Filed: Dec. 3, 2020
(86) PCT No.: PCT/US2020/063046

§ 371 Date: Jun. 3, 2022

Related U.S. Application Data
(60) Provisional application No. 62/943,908, filed on Dec. 5, 2019.

(51) Int. Cl. C09D 5/32; C01B 32/921; C01B 32/907; G02B 5/20

(52) U.S. Cl. CPC C09D 5/32; C01B 32/921; C01B 32/907; G02B 5/208; G02B 5/206; C01P 2004/03; C01P 2004/04; C01P 2006/40; C08K 3/14

(57) ABSTRACT

Compositions and devices comprising MXene materials, suitable for use as selective and/or tunable infrared emitters and/or absorbers, and methods of making coatings with low thermal emissivities using coatings comprising MXene materials.

### RELATED APPLICATIONS

The present application claims priority to and the benefit of U.S. patent application No. 62/943,908, “Selective Infrared Thermal Emission And Stealth Properties Of MXenes” (filed Dec. 5, 2019), the entirety of which application is incorporated herein by reference for any and all purposes.

### TECHNICAL FIELD

The present disclosure relates to the field of thermal emitters and to the field of radiation shields.

### BACKGROUND

Thermal emission in the infrared range is important in various fields, including infrared sensing, medicine, thermophotovoltaics, military and atmosphere science. In particular, thin, light and flexible films/coatings with selective infrared emissivity are highly desirable for portable and wearable devices.

Traditional low infrared emissivity has been achieved by smooth metals, but the metals' high density and susceptibility to surface oxidation that changes the emissivity can limit the metals' applications. In addition, traditional approaches pose a challenge to achieve broadband absorption in different frequency ranges (GHz˜THz). Accordingly, there is a long-felt need in the art for improved materials having low infrared emissivity and other useful absorption characteristics.

### SUMMARY

In meeting the described long-felt needs, provided are flexible and frequency-selective 2D metal carbides and nitrides (MXenes) films/coatings with low infrared emissivity (e.g., <0.2). Without being bound to any particular theory or approach, infrared emission of MXene can be controlled by electrochemical intercalation of ions from ionic liquid. Again without being bound to any particular theory, this class of metallic 2D materials has application to infrared radiation, which can be used in the target frequency ranges.

In one aspect, the present disclosure provides an infrared absorbing composition comprising at least one layer of MXene material.

Also provided are devices comprising a substrate and a composition according to the present disclosure.

Further provided are layered structures suitable for use as an infrared emitter/absorber, comprising: a reflecting layer having a first surface and a second surface, and an optical structure on the second surface of the reflecting layer having at least one partially transparent layer as well as at least one intermediate layer wherein the partially transparent layer is located at a distance from the reflective layer, and wherein the optical structure comprises at least one MXene material.

Also provided are methods for preparing a surface to absorb infrared radiation, the method comprising coating the surface with a coating comprising a composition according to the present disclosure.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 shows a multilayered structure of infrared emitter coating according to the invention.

FIGS. 2A-C provide representative morphologies of Mₙ₊₁XₙTₓ MXene flake in the infrared emitter coating. FIG. 2A shows SEM image of a single Mₙ₊₁XₙTₓ MXene flake showing the size of a MXene flake. FIG. 2B shows TEM image of Mₙ₊₁XₙTₓ MXene flakes showing the two-dimensional morphology of MXene flake. FIG. 2C provides a high-resolution TEM image of Mₙ₊₁XₙTₓ MXene flake showing few-layer structure of Mₙ₊₁XₙTₓ MXene flake.

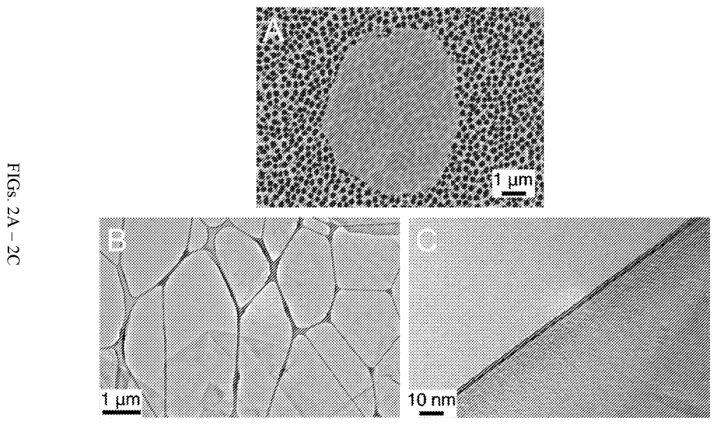

FIG. 3 shows an example of the average infrared emissivity as a function of the coating thickness in a wavelength range of 2-22 μm.

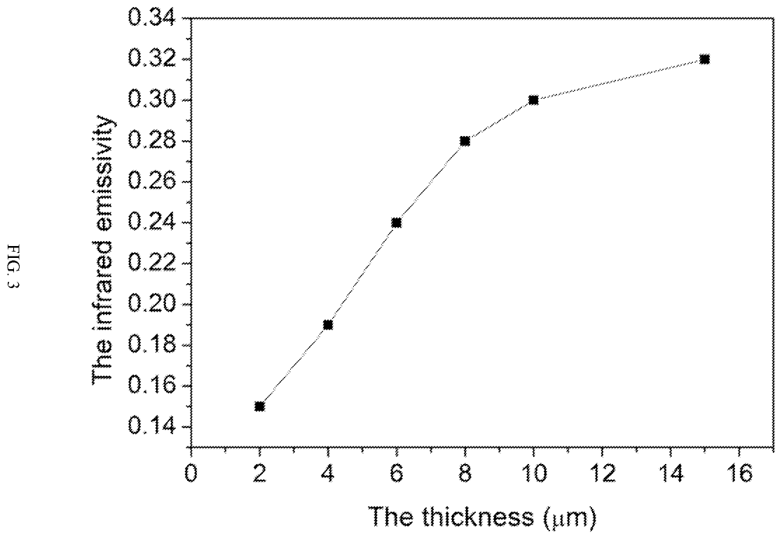

FIGS. 4A-4C provide infrared thermal images of different samples on a hot plate (˜80° C.), showing the low infrared emission of MXene coatings. (FIG. 4A) glass slide; (FIG. 4B) 30 nm thick MXene-coated glass slide; (FIG. 4C) 120 nm thick MXene-coated glass slide.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed technology.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Thermal emission in the infrared range is important in various fields, e.g., infrared sensing, medicine, thermophotovoltaics, military, and atmosphere science [1, 2]. Any object at finite temperature emits thermal radiation due to the thermally induced motion of particles and quasiparticles.

According to the Stefan-Boltzmann law of thermal radiation, the infrared radiation energy (E) of a real object at temperature T can be expressed as

E=εσT

where ε is a constant, and σ is the infrared emissivity. When there is no control of the temperature, the selective infrared emissivity is the only way to modulate the thermal radiation performance of an object.

Traditional materials having low infrared emissivity are smooth metals, such as Al, Ag, Ni, and others. But high density and easy surface oxidation that changes their emissivity limit the applications of these metals, and especially for portable and wearable devices being developed, thin, light and flexible films/coatings with selective infrared emissivity are highly desirable.

According to Kirchhoff's law and principle of conservation of energy, the relationship between the infrared emissivity (σ), absorptivity (A), and reflectivity (R) of nontransparent material can be expressed as σ=A=1−R. Thus, materials with low infrared reflectivity generally have high absorptivity and infrared emissivity, and vice versa.

Historically, it has been challenging to find a material with simultaneous low infrared reflectivity and emissivity, though this has been is constantly pursued in many technologies including the microwave-infrared compatible stealth. In particular, it is a challenge to achieve broadband absorption in different frequency ranges (GHz˜THz). Recent development of metasurfaces pointed out conceptually new methods to manipulate the electromagnetic waves [3, 4].

Design of nanophotonic structures offers an alternative way to controlling thermal radiation. Conventional thermal emitters have a set of common characteristics. The emitted radiation is typically incoherent, broadband, un-polarized, while the emission patterns of near-isotropic nanophotonic structures have shown thermal radiation characteristics that are drastically different from the conventional thermal radiators. See, e.g., [5] Inoue T, De Zoysa M, Asano T, et al. Realization of dynamic thermal emission control [J]. Nature Materials, 2014, 13 (10): 928 and [6] Liu B, Gong W, Yu B, et al. Perfect thermal emission by nanoscale transmission line resonators [J]. Nano letters, 2017, 17 (2): 666-672 for representative structures and data. Nanophotonic structures can produce coherent, narrowband, polarized and directional thermal radiation.

MXenes as Alternative to Current Materials

Compared with the bulk counterpart, a distinction for single or few-layer 2D (e.g., 2 to 10 layers) materials is the tunability of physical properties. MXenes are a class of 2D materials where M is a transition metal and X is carbon and/or nitrogen. Tuning the metal and X elements can vary properties, such as conductivity, optical properties, and the like. To date, many kinds of MXenes have been synthesized. Among many members of this large and quickly growing family, Ti₃C₂ receives particular attention because of its metallic properties and high conductivity, which characteristics exceed virtually all other 2D materials.

As shown in Table 1 (reported in [9] Calvert R L, Gagliardi J, Mclachlan A. D. Surface coatings for low emittance in the thermal surveillance band (No. MRL-R-937). Materials Research Labs Ascot Vale (Australia), 1984: 1-11 and [10] Wang F, Cheng L, Xiang L, et al. Effect of SiC coating and heat treatment on the thermal radiation properties of C/SiC composites [J]. Journal of the European Ceramic Society, 2014, 34 (7): 1667-1672), compared with oxides and carbon materials, metals have a relatively low infrared emissivity.

Generally, the surface condition of an object has a significant effect on the infrared emissivity. Although polished metals show quite low infrared emission, a smooth surface is not easily achieved or easily used in practical applications. As an example, Ti₃C₂Tₓ shows an infrared emissivity of 0.2 in a preliminary study on filtered films, which is competitive with metals. This result shows that Ti₃C₂Tₓ is useful for infrared stealth applications, and—without being bound to any particular theory—nitride MXenes can be even more conducting than carbide MXenes.

MXenes are, in particular, more suitable for flexible and wearable devices than metals, owing to their 2D structure. Free-standing MXene films of 0.2-5 microns thickness can be produced, and MXene coatings can be applied to the surface by simple spraying coating. In addition, different MXenes show a large range of infrared emissivity, which need a thorough study. MXenes have both higher capacitance and higher conductivity than multilayer solution processed graphene and can outperform graphene in active thermal camouflage as well. Thus, this class of metallic 2D materials is suitable for selective infrared radiation, which can be used in the target frequency ranges.

TABLE 1
The infrared emissivity of different MXene
films and typical materials ^{[9, 10]}

| Materials | | Average Infrared Emissivity |
|---|---|---|
| MXene | Ti₃C₂Tₓ | 0.20 (filtered film) |
| | Ti₃CNTₓ | 0.24 (filtered film) |
| | Mo₂TiC₂Tₓ | 0.42 (filtered film) |
| | Mo₂CTₓ | 0.60 (filtered film) |
| Metals | Al | 0.05(polished sheet), 0.48 (powder) |
| | Cu | 0.07(polished sheet), 0.62 (powder) |
| | Fe | 0.07(polished), 0.6 (powder) |
| | Mg | 0.07(polished), 0.86 (powder) |
| | Ni | 0.05(polished), 0.78 (powder) |
| Oxides | Al₂O₃ | 0.46 |
| | CuO | 0.7 |
| | NiO | 0.5~0.75 |
| | Cr₂O₃ | 0.87 |
| | SiC | 0.9 |
| | Carbon | >0.9 |

MXene Compositions

The present disclosure may be understood more readily by reference to the following description taken in connection with the accompanying Figures and Examples, all of which form a part of this disclosure. It is to be understood that this disclosure is not limited to the specific products, methods, conditions or parameters described or shown herein, and that the terminology used herein is for the purpose of describing particular embodiments by way of example only and is not intended to be limiting of any claimed invention.

Similarly, unless specifically otherwise stated, any description as to a possible mechanism or mode of action or reason for improvement is meant to be illustrative only, and the disclosure herein is not to be constrained by the correctness or incorrectness of any such suggested mechanism or mode of action or reason for improvement. Throughout this text, it is recognized that the descriptions refer to compositions and methods of making and using said compositions.

That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

MXene coatings may be applied using any of the methods described elsewhere herein, but exemplary methods include spray, spin, roller, or dip coating, or ink-printing or lithographic patterning. The MXene compositions may comprise any of the compositions described elsewhere herein.

Exemplary MXene compositions include, e.g., those compositions comprising:

(a) at least one layer having first and second surfaces, each layer described by a formula Mₙ₊₁XₙTₓ and comprising:

substantially two-dimensional array of crystal cells, each crystal cell having an empirical formula of Mₙ₊₁Xₙ, such that

each X is positioned within an octahedral array of M, wherein

M is at least one Group IIIB, IVB, VB, or VIB metal or Mn, wherein

each X is C, N, or a combination thereof;

n=1, 2, 3, or 4; and wherein

Tₓ represents surface termination groups; or

(b) at least one layer having first and second surfaces, each layer comprising:

a substantially two-dimensional array of crystal cells,

each crystal cell having an empirical formula of (M′,M″)ₙ₊₁XₙTₓ, such that each X is positioned within an octahedral array of M′ and M″, and where M″ are present as individual two-dimensional array of atoms intercalated between a pair of two-dimensional arrays of M′ atoms, or M′ and M″ are randomly distributed in the same layer.

wherein M′ and M″ are different Group IIIB, IVB, VB, or VIB metals,

wherein each X is C, N, or a combination thereof;

n=1, 2, 3, or 4; and wherein

Tₓ represents surface termination groups. In certain of these exemplary embodiments, the at least one of said surfaces of each layer has surface termination groups (Tₓ) comprising alkoxide, carboxylate, halide, hydroxide, hydride, oxide, sub-oxide, nitride, sub-nitride, sulfide, thiol, or a combination thereof. In certain preferred embodiments, the MXene composition has an empirical formula of Ti₃C₂.

While MXene compositions include any and all of the compositions described in the patent applications, issued patents, and other documents mentioned elsewhere herein, in some embodiments, MXenes are also materials comprising or consisting essentially of a Mₙ₊₁Xₙ(Tₛ) composition having at least one layer, each layer having a first and second surface, each layer comprising

a substantially two-dimensional array of crystal cells.

each crystal cell having an empirical formula of Mₙ₊₁Xₙ, such that each X is positioned within an octahedral array of M,

wherein M is at least one Group 3, 4, 5, 6, or 7,

wherein each X is C and/or N, and

n=4;

wherein at least one of said surfaces of the layers has surface terminations, Tₛ, independently comprising alkoxide, alkyl, carboxylate, halide, hydroxide, hydride, oxide, sub-oxide, nitride, sub-nitride, sulfide, sulfonate, thiol, or a combination thereof.

Each of these compositions is considered an independent embodiment. Similarly, MXene carbides, nitrides, and carbonitrides are also considered independent embodiments. Various MXene compositions are described elsewhere herein, and these and other compositions, including coatings, stacks, laminates, molded forms, and other structures, described in the above-mentioned references are all considered within the scope of the present disclosure.

While the instant disclosure describes the use of Ti₃C₂, because of the convenient ability to prepare larger scale quantities of these materials, it is believed and expected that all other MXenes will perform similarly, and so all such MXene compositions are considered within the scope of this disclosure. In certain embodiments, the MXene composition is any of the compositions described in at least one of U.S. patent application Ser. No. 14/094,966 (filed Dec. 3, 2013), 62/055,155 (filed Sep. 25, 2014), 62/214,380 (filed Sep. 4, 2015), 62/149,890 (filed Apr. 20, 2015), 62/127,907 (filed Mar. 4, 2015) or International Applications PCT/US2012/043273 (filed Jun. 20, 2012), PCT/US2013/072733 (filed Dec. 3, 2013), PCT/US2015/051588 (filed Sep. 23, 2015), PCT/US2016/020216 (filed Mar. 1, 2016), or PCT/US2016/028,354 (filed Apr. 20, 2016), preferably where the MXene composition comprises titanium and carbon (e.g., Ti₃C₂, Ti₂C, Mo₂TiC₂, etc.), and PCT/US2020/054912 (filed Oct. 9, 2020). Each of these compositions is considered independent embodiment.

Similarly, MXene carbides, nitrides, and carbonitrides are also considered independent embodiments. Various MXene compositions are described elsewhere herein, and these and other compositions, including coatings, stacks, laminates, molded forms, and other structures, described in the above-mentioned references are all considered within the scope of the present disclosure.

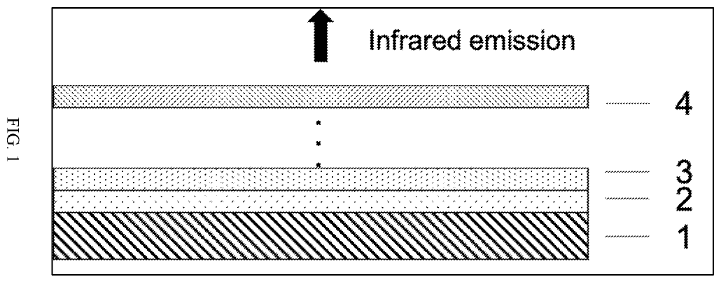

A single- or multi-layered infrared emitter coating according to an exemplary embodiment of the invention is schematically illustrated in FIG. 1. Where the MXene material is present as a coating on a conductive or non-conductive substrate (element 1), that MXene coating may cover some or all of the underlying substrate material. Such substrates may be virtually any conducting or non-conducting material, though preferably the MXene coating is superposed on a non-conductive surface. Such non-conductive surfaces or bodies may comprise virtually any non-electrically conducting organic polymer, inorganic material (e.g., glass or silicon).

Because MXenes can be produced as a free-standing film, or applied to any shaped surface, the MXene can be applied to almost any substrate material, depending on the intended application, with little dependence on morphology and roughness. In independent embodiments, the substrate may be a non-porous, porous, microporous, or aerogel form of an organic polymer, for example, a fluorinated or perfluorinated polymer (e.g., PVDF, PTFE) or an alginate polymer, a silicate glass, silicon, GaAs, or other low-k dielectric, an inorganic carbide (e.g., SiC) or nitride (Al₃N₄) or other thermally conductive inorganic material wherein the choice of substrate depends on the intended application. Depending on the nature of the application, low-k dielectrics or high thermal conductivity substrates may be used.

In some embodiments, the substrate is rigid (e.g., on a silicon wafer). In other embodiments, substrate is flexible (e.g., on a flexible polymer sheet). Substrate surfaces may be organic, inorganic, or metallic, and comprise metals (Ag, Au, Cu, Pd, Pt) or metalloids; conductive or non-conductive metal oxides (e.g., SiO2, ITO), nitrides, or carbides; semi-conductors (e.g., Si, GaAs, InP); glasses, including silica or boron-based glasses; or organic polymers.

The coating may be patterned or unpatterned on the substrate. In independent embodiments, the coatings may be applied or result from the application by spin coating, dip coating, roller coating, compression molding, doctor blading, ink printing, painting or other such methods. The coating may include one layer (element 2) or two layers (element 3), or multiple layers (element 4), e.g., more than 2 layers. Multiple coatings of the same or different MXene compositions may be employed.

Flat surface or surface-patterned substrates can be used. The MXene coatings may also be applied to surfaces having patterned metallic conductors or wires. Additionally, by combining these techniques, it is possible to develop patterned MXene layers by applying a MXene coating to a photoresist layer, either a positive or negative photoresist, photopolymerize the photoresist layer, and develop the photopolymerized photoresist layer.

During the developing stage, the portion of the MXene coating adhered to the removable portion of the developed photoresist is removed. Alternatively, or additionally, the MXene coating may be applied first, followed by application, processing, and development of a photoresist layer. By selectively converting the exposed portion of the MXene layer to an oxide using nitric acid, a MXene pattern may be developed. In short, these MXene materials may be used in conjunction with any appropriate series of processing steps associated with thick or thin film processing to produce any of the structures or devices described herein (including, e.g., plasmonic nanostructures).

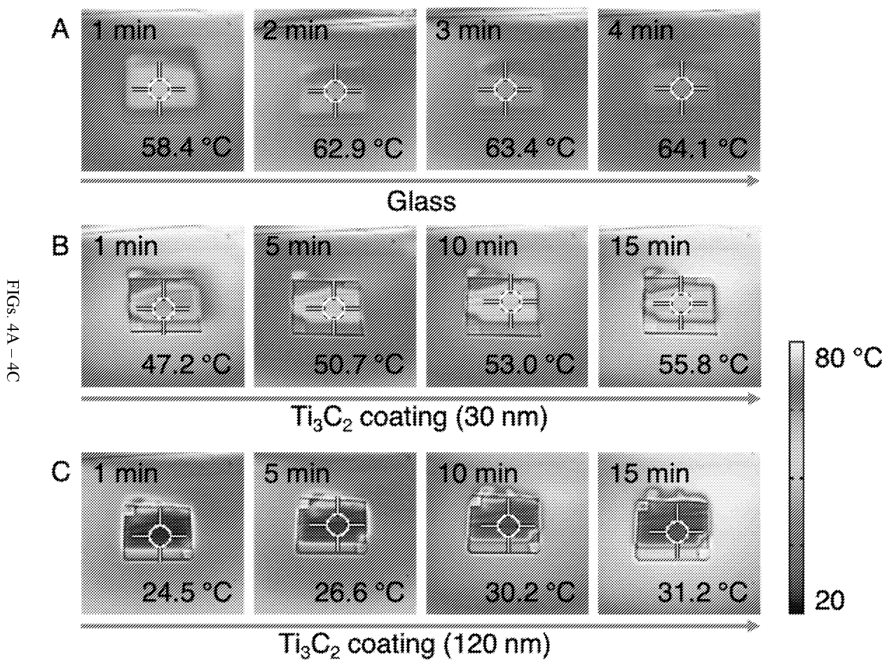

FIG. 4 shows infrared thermal images of Ti₃C₂-coated glass slides on a hot plate (˜80° C.). Here, a pure glass slide without coating is used as a reference, as shown in FIG. 4A. After only 4 mins, the infrared temperature of the glass slide has increased from the environmental temperature to ˜64° C. When the Ti₃C₂ solution was sprayed on glass substrate, the infrared emission decreases obviously. The infrared temperature increases from the environmental temperature to ˜56° C. after 15 mins for a 30 nm thick MXene coating (FIG. 4B), while that only increases to ˜31° C. for a 120 nm thick MXene coating (FIG. 4C). It is thus demonstrated that Ti₃C₂ MXene has an extremely low infrared emissivity. The methods and compositions described in PCT/US2015/051588 (filed Sep. 23, 2015) and PCT/US2020/054912 (filed Oct. 9, 2020), incorporated by reference herein in their entireties, are suitable for such applications.

In independent embodiments, the MXene coating can be present and is operable, in virtually any thickness, from the nanometer scale to hundreds of microns. Within this range, in some embodiments, the MXene may be present at a thickness ranging from 1-2 nm to 1000 microns, or in a range defined by one or more of the ranges of from 1-2 nm to 25 nm, from 25 nm to 50 nm, from 50 nm to 100 nm, from 100 nm to 150 nm, from 150 nm to 200 nm, from 200 nm to 250 nm, from 250 nm to 500 nm, from 500 nm to 1000 nm, from 1000 nm to 1500 nm, from 1500 nm to 2500 nm, from 2500 nm to 5000 nm, from 5 μm to 100 μm, from 100 μm to 500 μm, or from 500 μm to 1000 μm.

Typically, in such coatings, the MXene is present as an overlapping array of two or more overlapping layers of MXene platelets oriented to be essentially coplanar with the substrate surface. In specific embodiments, the MXene platelets have at least one mean lateral dimension in a range of from about 0.1 micron to about 50 microns, or in a range defined by one or more of the ranges of from 0. 1 to 2 microns, from 2 microns to 4 microns, from 4 microns to 6 microns, from 6 microns to 8 microns, from 8 microns to 10 microns, from 10 microns to 20 microns, from 20 microns to 30 microns, from 30 microns to 40 microns, or from 40 microns to 50 microns.

Again, the substrate may also be present such that its body is a molded or formed body comprising the MXene composition. While such compositions may comprise any of the MXene compositions described herein, exemplary methods of making such structures are described in PCT/US2015/051588 (filed Sep. 23, 2015), which is incorporated by reference herein at least for such teachings.

To this point, the disclosure(s) have been described in terms of the methods and derived coatings or compositions themselves, the disclosure also contemplates that devices incorporating or comprising these thin films are considered within the scope of the present disclosure(s). Additionally, any of the devices or applications described or discussed elsewhere herein are considered within the scope of the present disclosure(s)

Additional Terms

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment.

Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed disclosure.

Embodiments described in terms of the phrase “comprising” (or its equivalents), also provide, as embodiments, those which are independently described in terms of “consisting of” and “consisting essentially of.” Where the term “consisting essentially of” is used, the basic and novel characteristic(s) of the method is intended to be the ability of the MXene materials to exhibit selective infrared thermal emission and absorption properties.

Throughout this specification, words are to be afforded their normal meaning, as would be understood by those skilled in the relevant art. However, so as to avoid misunderstanding, the meanings of certain terms will be specifically defined or clarified.

While MXene compositions include any and all of the compositions described in the patent applications and issued patents described above, in some embodiments, MXenes are materials comprising or consisting essentially of a Mₙ₊₁Xₙ(Tₛ) composition having at least one layer, each layer having a first and second surface, each layer comprising

a substantially two-dimensional array of crystal cells.

each crystal cell having an empirical formula of Mₙ₊₁Xₙ, such that each X is positioned within an octahedral array of M,

wherein M is at least one Group 3, 4, 5, 6, or 7, or Mn,

wherein each X is carbon and nitrogen or combination of both and

n=1, 2, or 3;

wherein at least one of said surfaces of the layers has surface terminations, Tₛ, independently comprising alkoxide, alkyl, carboxylate, halide, hydroxide, hydride, oxide, sub-oxide, nitride, sub-nitride, sulfide, sulfonate, thiol, or a combination thereof;

As described elsewhere within this disclosure, the Mₙ₊₁Xₙ(Tₛ) materials produced in these methods and compositions have at least one layer, and sometimes a plurality of layers, each layer having a first and second surface, each layer comprising a substantially two-dimensional array of crystal cells; each crystal cell having an empirical formula of Mₙ₊₁Xₙ, such that each X is positioned within an octahedral array of M, wherein M is at least one Group 3, 4, 5, 6, or 7 metal (corresponding to Group IIIB, IVB, VB, VIB or VIIB metal or Mn), wherein each X is C and/or N and n=1, 2, or 3; wherein at least one of said surfaces of the layers has surface terminations, Ts, comprising alkoxide, alkyl, carboxylate, halide, hydroxide, hydride, oxide, sub-oxide, nitride, sub-nitride, sulfide, sulfonate, thiol, or a combination thereof.

Supplementing the descriptions above, Mₙ₊₁Xₙ(Tₛ), compositions may be viewed as comprising free standing and stacked assemblies of two dimensional crystalline solids. Collectively, such compositions are referred to herein as “Mₙ₊₁Xₙ(Tₛ),” “MXene,” “MXene compositions,” or “MXene materials.” Additionally, these terms “Mₙ₊₁Xₙ(Tₛ),” “MXene,” “MXene compositions,” or “MXene materials” also refer to those compositions derived by the chemical exfoliation of MAX phase materials, whether these compositions are present as free-standing 2-dimensional or stacked assemblies (as described further below). Reference to the carbide equivalent to these terms reflects the fact that X is carbon, C, in the lattice.

Such compositions comprise at least one layer having first and second surfaces, each layer comprising: a substantially two-dimensional array of crystal cells; each crystal cell having an empirical formula of Mₙ₊₁Xₙ, where M, X, and n are defined above. These compositions may be comprised of individual or a plurality of such layers. In some embodiments, the Mₙ₊₁Xₙ(Tₛ) MXenes comprising stacked assemblies may be capable of, or have atoms, ions, or molecules, that are intercalated between at least some of the layers. In other embodiments, these atoms or ions are lithium.

In still other embodiments, these structures are part of an energy-storing device, such as a battery or supercapacitor. In other embodiments, the intercalated ions are one or more of an alkali metal or alkaline earth metal ion. In still other embodiments these structures are added to polymers to make polymer composites.

The term “crystalline compositions comprising at least one layer having first and second surfaces, each layer comprising a substantially two-dimensional array of crystal cells” refers to the unique character of these MXene materials. For purposes of visualization, the two-dimensional array of crystal cells may be viewed as an array of cells extending in an x-y plane, with the z-axis defining the thickness of the composition, without any restrictions as to the absolute orientation of that plane or axes. It is preferred that the at least one layer having first and second surfaces contain but a single two-dimensional array of crystal cells (that is, the z-dimension is defined by the dimension of approximately one crystal cell), such that the planar surfaces of said cell array defines the surface of the layer; it should be appreciated that real compositions may contain portions having more than single crystal cell thicknesses.

That is, as used herein, “a substantially two-dimensional array of crystal cells” refers to an array which preferably includes a lateral (in x-y dimension) array of crystals having a thickness of a single cell, such that the top and bottom surfaces of the array are available for chemical modification.

Metals of Group 3, 4, 5, 6, or 7 (corresponding to Group IIIB, IVB, VB, VIB, or VIIB), either alone or in combination, said members including Ti, Zr, Hf, V, Nb, Ta, Cr, Mo, and W. For the purposes of this disclosure, the terms “M” or “M atoms,” “M elements,” or “M metals” may also include Mn. Also, for purposes of this disclosure, compositions where M comprises Ti, Zr, Hf, V, Nb, Ta, Cr, Mo, W, or mixtures thereof constitute independent embodiments. Similarly, the oxides of M may comprise any one or more of these materials as separate embodiments. For example, M may comprise any one or combination of Hf, Cr, Mn, Mo, Nb, Sc, Ta, Ti, V, W, or Zr. In other preferred embodiments, the transition metal is one or more of Ti, Zr, V, Cr, Mo, Nb, Ta, or a combination thereof. In even more preferred embodiments, the transition metal is Ti, Ta, Mo, Nb, V, Cr, or a combination thereof.

In certain specific embodiments, Mₙ₊₁Xₙ comprises Mₙ₊₁Cₙ (i.e., where X=C, carbon) which may be Ti₂C, V₂C, V₂N, Cr₂C, Zr₂C, Nb₂C, Hf₂C, Ta₂C, Mo₂C, Ti₃C₂, V₃C₂, Ta₃C₂, Mo₃C₂, (Cr_{2/3} Ti_{1/2})₃C₂, Ti₄C₃, V₄C₃, Ta₄C₃, Nb₄C₃, or a combination thereof.

In more specific embodiments, the Mₙ₊₁Xₙ(Tₛ) crystal cells have an empirical formula Ti₃C₂ or Ti₂C. In certain of these embodiments, at least one of said surfaces of each layer of these two-dimensional crystal cells is coated with surface terminations, Tₛ, comprising alkoxide, fluoride, hydroxide, oxide, sub-oxide, sulfonate, or a combination thereof.

The range of compositions available can be seen as extending even further when one considers that each M-atom position within the overall Mₙ₊₁Xₙ matrix can be represented by more than one element. That is, one or more type of M-atom can occupy each M-position within the respective matrices. In certain exemplary non-limiting examples, these can be (M^{A}ₓM^{B}_{y})₂C, (M^{A}ₓM^{B}_{y})₃C₂, or (M^{A}ₓM^{B}_{y})₄C₃, where M^{A} and M^{B} are independently members of the same group, and x+y=1. For example, in but one non-limiting example, such a composition can be (V_{1/2}Cr_{1/2})₃C₂.

MXenes are also materials comprising or consisting essentially of a Mₙ₊₁Xₙ(Tₛ) composition having at least one layer, each layer having a first and second surface, each layer comprising

a substantially two-dimensional array of crystal cells.

each crystal cell having an empirical formula of Mₙ₊₁Xₙ, such that each X is positioned within an octahedral array of M,

wherein M is at least one Group 3, 4, 5, 6, or 7,

wherein each X is C and/or N, and

n=4;

wherein at least one of said surfaces of the layers has surface terminations, Tₛ, independently comprising alkoxide, alkyl, carboxylate, halide, hydroxide, hydride, oxide, sub-oxide, nitride, sub-nitride, sulfide, sulfonate, thiol, or a combination thereof.

The range of compositions available can be seen as extending even further when one considers that each M-atom position within the overall Mₙ₊₁Xₙ matrix can be represented by more than one element. That is, one or more type of M-atom can occupy each M-position within the respective matrices. In certain exemplary non-limiting examples, these can be (M′ₐM″_{b})X₄, where M′ and M″ are different metals (e.g., members of the same group), and a+b=5; or (M′ₐM″_{b})₅X₄Tₓ, where M′ and M″ are different metals (e.g., members of the same group), and a+b=1. As some non-limiting examples, such a composition can be (V_{1/2}Nb_{1/2})₅C₄ or (V_{1/3}Nb_{2/3})₅N₄.

In the same way, one or more type of X-atom can occupy each X-position within the matrices, for example solid solutions of the formulae M₅(CⱼNₖ)₄ (where j+k=1); (M′ₐM″_{b})(CⱼNₖ)₄ (where a+b=5 and j+k=1); and (M′ₐM″_{b})₅(CⱼNₖ)₄ (where a+b=1 and j+k=1).

Each of these compositions is considered an independent embodiment. Similarly, MXene carbides, nitrides, and carbonitrides are also considered independent embodiments. Various MXene compositions are described elsewhere herein, and these and other compositions, including coatings, stacks, laminates, molded forms, and other structures, described in the above-mentioned references are all considered within the scope of the present disclosure.

Exemplary Constructions/Applications

Thermal emitters and absorbers as contemplated herein are known in the art for material other than with MXene materials. The present disclosure contemplates using MXene materials in place or in addition to the materials used in such constructions. For example, U.S. Pat. No. 10,001,409 (“the 049 Patent”) describes the use of semi-transparent metal layer in layered emitter structures. It is contemplated herein that the present disclosure captures the general structures, materials, and methods used in the 049 Patent, in which MXenes are used in place or in addition to the semi-transparent materials disclosed therein.

Likewise, US Patent Application Publ. No. 2015/0241612 (“the '612 Publication”) describes an optical layered structure designed for use as an infrared detector, emitter, and reflecting surface. It is contemplated herein that the present disclosure captures the general structures, materials, and methods used in the '612 Publication, in which MXenes are used in place or in addition to the partially-transparent or transparent materials disclosed therein.

As those skilled in the art will appreciate, numerous modifications and variations of the present invention are possible in light of these teachings, and all such are contemplated hereby. All references cited within this specification are incorporated by reference in their entireties for all purposes, or at least for their teachings in the context of their recitation.

Embodiments

The following Embodiments are illustrative only and do not limit the scope of the present disclosure or the appended claims.

Embodiment 1. An infrared absorbing composition comprising at least one layer of MXene material.

Such a composition can include one, two, three, or more MXene materials. Such a composition can also comprise one, two, three, four, five, six, seven, eight, nine, or more layers of MXene materials. As an example, the composition can comprise from two to ten layers of MXene materials.

A composition can include MXene materials that differ from one another. Such materials can differ in terms of their M (transition metal) element, their X (carbon/nitrogen) element, and/or even in terms of their terminations.

For example, a composition can include one or more layers of MXene material having thiol terminations and one or more layers of MXene material having hydroxyl terminations. A composition can include, e.g., one or more layers of Ti₃C₂Tₓ MXene and one or more layers of Ti₃N₂Tₓ MXene.

The composition can include alternating layers of different MXene materials, MXene materials arranged in a repeating A-B-C-A-B-C arrangement, MXene materials arranged in an A-B-C-D-A-B-C-D arrangement, MXene materials arranged in an A-B-C-D-E-A-B-C-D-E arrangement, MXene materials arranged in an A-A-B-B-C-C arrangement, and subsets thereof.

As an example, a composition can include MXene materials arranged in an A-B-C-A-B arrangement, or an A-B-C-A arrangement, i.e., an arrangement that includes a complete repeat unit of multiple MXene materials and a partial repeat unit. A composition can include one or more layers of carbide MXene materials and one or more layers of nitride MXene materials.

Embodiment 2. The composition of Embodiment 1, wherein the composition comprises a binder. A binder can be, e.g., a polymer or polymers. The polymer can include aromatic groups (e.g., polystyrene, polyphenylene sulfide), though this is not a requirement. The polymer can be a thermoplastic polymer, but can also be a thermosetting polymer.

Embodiment 3. The composition of any one of Embodiments 1 to 2, wherein the composition has an infrared emissivity of less than about 0.3. A composition can have an emissivity of less than about 0.25, less than about 0.20, less than about 0.15, less than about 0.10, or even less than about 0.05. A composition can have an infrared emissivity of from about 0.05 to about 0.30, from about 0.05 to about 0.25, from about 0.10 to about 0.20, or even about 0.15. The composition can have an infrared emissivity of from about 0.15 to about 0.30.

Embodiment 4. The composition of any one of Embodiments 1 to 3, wherein the composition comprises a MXene layer adjacent to a non-MXene layer. For example, a composition can include a MXene layer adjacent to a non-MXene layer, e.g., a transparent polymer layer or even a glass, silicon, or other layer. A composition can include MXene pieces (e.g., platelets) that are oriented to be coplanar with one another, but this is not a requirement, as a composition can also include MXene pieces that are randomly oriented relative to one another. A composition can include a first population of MXene pieces that are in a first orientation and a second population of MXene pieces that are in a second orientation that differs from the first orientation.

For example, a composition can include one or more layers that comprise a first population of MXene platelets that define major axes that are in turn oriented along a first axis. The composition can include one or more layers that comprise a second population of MXene platelets that define major axes that are in turn oriented along a second axis, whereby the first and second axes are not parallel to one another. In some embodiments, however, the first and second axes are parallel to one another.

Embodiment 5. The composition of any one of Embodiments 1 to 4, wherein the layers comprise at least two kinds of MXene materials. At least one layer can comprise a metallic MXene material.

Embodiment 6. The composition of any one of Embodiments 1 to 5, wherein the at least one MXene materials are metallic or semi-conductive.

Embodiment 7. The composition of any one of Embodiments 1 to 6, wherein the at least one layer of MXene material comprise intercalated ions, optionally electrochemically intercalated from ionic liquid.

Intercalated ions can be, e.g., alkali metals, alkaline earth metals. Sodium, potassium, and lithium are considered particularly suitable such ions. Different layers in a given composition can include different intercalated ions, e.g., a first MXene layer may comprise intercalated sodium ions, and a second MXene layer can comprise intercalated potassium ions.

Embodiment 8. A device comprising a substrate and a composition of any one of Embodiments 1 to 7.

The composition can be spaced from the substrate, e.g., by one or more non-MXene layers. This is not a requirement, however, as the composition can be disposed directly on the substrate. As an example, a composition according to the present disclosure can be placed directly onto a glass substrate. Alternatively, a binder or adhesive can be disposed between the substrate and the disclosed composition. The presence of a binder or adhesive is not a requirement.

The device can be, e.g., a radiation shield. Such a shield can be positioned between a source of radiation (e.g., a source of infrared radiation) and a detector or between the source of radiation and the environment exterior to the source of radiation. The device can be positioned so as to absorb at least some of the radiation emitted by a radiation source, e.g., an engine, a turbine, a cooking element, a body, and the like. The shield can be movable, e.g., so as to be positionable so as to most effectively interpose between the radiation source and the environment exterior to the radiation source. A device can be tubular, e.g., to at least partially enclose a source of radiation. A device can also be bendable, e.g., such that it can conform to a user's desired shape. Such devices can be hand-bendable.

A device can be configured such that it is person-portable. As an example, a device can be configured such that the device fits in a backpack or other baggage.

A device can also be characterized as an emitter. In such embodiments, the infrared absorbing composition comprising at least one layer of MXene material can be disposed so as to receive a signal or a radiation, e.g., a voltage, an illumination, or a magnetic field, and then emit a further signal. For example, the infrared absorbing composition comprising at least one layer of MXene material can be illuminated by a radiation and in turn emit a signal that is only a subpart of that radiation, e.g., radiation that is reflected and not absorbed by the infrared absorbing composition comprising at least one layer of MXene material. In this way, the infrared absorbing composition comprising at least one layer of MXene material can operate as a sort of filter or bandpass, absorbing or otherwise attenuating only certain portions of a radiation or a signal. For example, the infrared absorbing composition can comprise two or more kinds of MXene materials, e.g., Ti₃C₂Tₓ and V₂CTₓ, or Nb₄C₃Tₓ and Nb₂CTₓ. The different MXene materials can be mixed into the same layer or stacked in different layers, i.e., with each layer comprising a different MXene material. In this way, the infrared absorbing composition comprising at least one layer of MXene material can operate as a sort of filter in multiple infrared bands.

Embodiment 9. The device according to Embodiment 8, wherein the device comprises one or more electrodes and/or controls configured to tune the infrared emissivity of the MXene material. The response frequency of different MXene materials can be changed by applying voltage, resulting in the tunability of infrared emissivity.

As an example, a device can include a source of current, which source of current is configured to apply a current (e.g., via one or more electrodes) to at least a portion of the MXene composition. A device can include a power source, e.g., a battery, that provides the electrical current.

Without being bound to any particular theory, a portion of the device can comprise a MXene capacitor. A device can also include a source of magnetic field.

Again without being bound to any particular theory, the characteristic absorbance of the disclosed MXene compositions can shift to higher frequency with application of a voltage to the composition.

As an example of a shielding system, such a system can include a sensor that is configured to detect one or more of infrared radiation being emitted from the MXene composition, radiation being applied to the MXene composition, or even ambient infrared radiation. In response to this detection, the signal can be configured to modulate (e.g., in real time, according to a predetermine scheduled, or on some other interval) the voltage applied to the MXene so as to optimize the MXene's absorbance characteristics based on that detected radiation.

For example, if the system detects an infrared radiation at a wavelength that differs from the wavelength for which the MXene composition has an optimal absorption, the system can modulate a voltage applied to the MXene composition so as to adjust the absorption characteristics of the MXene composition. A system can also be configured to apply a voltage to the MXene composition according to a pre-set schedule or table, e.g., to apply a first voltage value if the detected radiation is within a first wavelength range, to apply a second wavelength if the detected radiation is within a second wavelength range, and so on.

Similarly, a system can be configured to adjust a voltage applied to the MXene composition based on another signal received by the system. For example, a system can be configured to apply a first voltage to the MXene composition if the system receives a signal that an emitter is emitting (or is expected to emit) a first certain radiation (e.g., that the emitted is operating in a first mode that emits a first radiation), and apply a second voltage to the MXene composition if the system receives a signal that the emitted is emitting (or is expected to emit) a second certain radiation.

Embodiment 10. The device of any one of Embodiments 8 to 9, further comprising an electronic liquid or other source of ions that can intercalate into the MXene materials.

Embodiment 11. The device of any one of Embodiments 8 to 10, wherein the substrate is flexible.

The substrate can be flexible, e.g., a cloth or article of clothing. Clothing having MXene materials disposed thereon is considered particularly suitable, as such clothing can be used to camouflage the wearer, e.g., by reducing the wearer's thermal or other signature.

Embodiment 12. The device of any one of Embodiments 8 to 10, wherein the substrate is rigid. The substrate can be, e.g., body armor, a helmet, a vehicle component (such as a panel), glass, plastic, silicon, and the like.

Embodiment 13. A layered structure configured for use as an infrared emitter/absorber, comprising: a reflecting layer having a first surface and a second surface, and an optical structure on the second surface of the reflecting layer having at least one partially transparent layer as well as at least one intermediate layer wherein the partially transparent layer is located at a distance from the reflective layer, and wherein the optical structure comprises at least one MXene material.

Any one or more of the at least one partially transparent layer and the at least one intermediate layer can comprise one or more MXene materials. The reflecting layer can comprise a substrate, e.g., a metallic substrate, a polymeric substrate, and the like. The intermediate layer can be disposed between the reflecting layer and the partially transparent layer. For example, a layered structure used as an infrared absorber can comprise Ti₃C₂Tₓ as a reflected layer; Nb₂CTₓ as an intermediate layer; and polydimethylsiloxane as a transparent substrate.

The layered structure can itself be optically transparent or nearly transparent. In this way, a layered structure can be, e.g., placed over an optical terminal or monitor so as to permit visible light to reach the user, while also absorbing and/or filtering infrared radiation. Such a layered structure can also be used to provide a transparent infrared absorber or filter between a user and a source of infrared radiation, e.g., in glasses, goggles, a window, a windshield, a porthole, or a visor. Alternatively, such a layered structure can be disposed (e.g., as a coating on clothing or protective gear or armor) so as to block, absorb, filter, or attenuate infrared radiation from the user from reaching a detector or environment exterior to the user.

In some embodiments, a composition or structure according to the present disclosure is placed between an emitting device (e.g., a radiation source) and the environment that is exterior to the emitting device so that the MXene composition acts as a filter that blocks (or attenuates) at least some of the IR that comes from the emitting device. The composition or structure can be optically transparent, but this is not a requirement.

Embodiment 14. The layered structure of Embodiment 13, wherein the at least one partially transparent layer comprises a glass.

Embodiment 15. The layered structure of Embodiment 13, wherein the at least one partially transparent layer comprises a polymer.

Embodiment 16. The layered structure of Embodiment 13, wherein the intermediate layer comprises a MXene material.

Embodiment 17. A method for preparing a surface to absorb infrared radiation, the method comprising coating the surface with a coating comprising a composition according to any one of Embodiments 1 to 7.

Embodiment 18. The method of Embodiment 17, wherein the coating is accomplished by one or more or spraying, spin coating, dip coating, roller coating, compression molding, doctor blading, ink printing, painting, or any combination thereof

Embodiment 19. The method of any one of Embodiments 17 to 18, further comprising curing a binder within the coating.

Embodiment 20. The method of any one of Embodiments 17 to 19, further comprising effecting intercalation of ions into the coating.

Suitable ions or organic molecules are described elsewhere herein. Such ions/molecules can be, e.g., alkali metal, alkaline earth metal ions, or organoammonium cations.

### REFERENCES

The following references are provided for convenience.

[1] Raman A P, Anoma M A, Zhu L, et al. Passive radiative cooling below ambient air temperature under direct sunlight [J]. Nature, 2014, 515 (7528): 540.

[2] Zhang G, Huang S, Chaves A, et al. Infrared fingerprints of few-layer black phosphorus [J]. Nature Communications, 2017, 8: 14071.

[3] Coppens Z J, Valentine J G. Spatial and temporal modulation of thermal emission [J]. Advanced Materials, 2017, 29 (39): 1701275.

[4] Xie X, Li X, Pu M, et al. Plasmonic metasurfaces for simultaneous thermal infrared invisibility and holographic illusion [J]. Advanced Functional Materials, 2018, 28 (14): 1706673.

[5] Inoue T, De Zoysa M, Asano T, et al. Realization of dynamic thermal emission control [J]. Nature Materials, 2014, 13 (10): 928.

[6] Liu B, Gong W, Yu B, et al. Perfect thermal emission by nanoscale transmission line resonators [J]. Nano letters, 2017, 17 (2): 666-672.

[7] Naguib M, Kurtoglu M, Presser V, et al. Two-dimensional nanocrystals produced by exfoliation of Ti₃AlC₂ [J]. Advanced Materials, 2011, 23 (37): 4248-4253.

[8] Salihoglu O, Uzlu H B, Yakar O, et al. Graphene-based adaptive thermal camouflage [J]. Nano Letters, 2018, 18 (7): 4541-4548.

[9] Calvert R L, Gagliardi J, Mclachlan A. D. Surface coatings for low emittance in the thermal surveillance band (No. MRL-R-937). Materials research labs ascot vale (Australia), 1984: 1-11.

[10] Wang F, Cheng L, Xiang L, et al. Effect of SiC coating and heat treatment on the thermal radiation properties of C/SiC composites [J]. Journal of the European Ceramic Society, 2014, 34 (7): 1667-1672.

1. An infrared absorbing composition comprising at least one layer of MXene material.

2. The composition of claim 1, wherein the composition comprises a binder.

3. The composition of claim 1, wherein the composition has an infrared emissivity of less than about 0.3.

4. The composition of claim 1, wherein the composition comprises a MXene layer adjacent to a non-MXene layer.

5. The composition of claim 1, wherein the layers comprise at least two kinds of MXene materials.

6. The composition of claim 1, wherein the at least one MXene materials are metallic or semi-conductive.

7. The composition of claim 1, wherein the at least one layer of MXene material comprise intercalated ions, optionally electrochemically intercalated from ionic liquid.

8. A device comprising a substrate and a composition of claim 1.

9. The device according to claim 8, wherein the device comprises one or more electrodes and/or controls configured to tune the infrared emissivity of the MXene material.

10. The device of claim 8, further comprising an electronic liquid or other source of ions that can intercalate into the MXene materials.

11. The device of claim 8, wherein the substrate is flexible.

12. The device of claim 8, wherein the substrate is rigid.

13. A layered structure configured for use as an infrared emitter/absorber, comprising: a reflecting layer having a first surface and a second surface, and an optical structure on the second surface of the reflecting layer having at least one partially transparent layer as well as at least one intermediate layer wherein the partially transparent layer is located at a distance from the reflective layer, and wherein the optical structure comprises at least one MXene material.

14. The layered structure of claim 13, wherein the at least one partially transparent layer comprises a glass.

15. The layered structure of claim 13, wherein the at least one partially transparent layer comprises a polymer.

16. The layered structure of claim 13, wherein the intermediate layer comprises a MXene material.

17. A method for preparing a surface to absorb infrared radiation, the method comprising coating the surface with a coating comprising a composition according to claim 1.

18. The method of claim 17, wherein the coating is accomplished by one or more or spraying, spin coating, dip coating, roller coating, compression molding, doctor blading, ink printing, painting, or any combination thereof.

19. The method of claim 17, further comprising curing a binder within the coating.

20. The method of claim 17, further comprising effecting intercalation of ions into the coating.
